(19) United States
(12) Patent Application Publication
(10) Pub. No.: US 2025/0077869 A1
(43) Pub. Date: Mar. 6, 2025

(54) COMPRESSION FOR QUANTIZING MODEL WEIGHTS

(71) Applicant: MICROSOFT TECHNOLOGY LICENSING, LLC, Redmond, WA (US)

(72) Inventor: Ashraf Ayman MICHAIL, Kirkland, WA (US)

(21) Appl. No.: 18/456,838

(22) Filed: Aug. 28, 2023

(51) Int. Cl. G06N 3/082; G06N 3/0455

(52) U.S. Cl. CPC G06N 3/082; G06N 3/0455

(57) ABSTRACT

Methods are described for improving processing and storage efficiencies in large language models (LLMs) while also improving numerical accuracy. The methods are referred as distribution encoding. The disclosed distribution encoding techniques exploit the non-uniform distribution of model weights to provide improved numerical accuracy and compression, and consequently can reduce the number of GPU's needed for inferencing. This in turn enables the reduction of resources and cost necessary to implement such models.

### BACKGROUND

Large language models (LLMs) are a recent development in the field of natural language processing (NLP). LLMs can apply deep learning algorithms, referred to as machine learning (ML), to leverage massive amounts of data, which can result in highly accurate language processing capabilities. Some example LLMs include GPT-3 and BERT, which are trained on vast amounts of text data, allowing them to model complex relationships in language and highly accurate predictions for a wide range of language tasks such as: translation, summarization, and responses to questions. This has led to breakthroughs in areas like chatbots, virtual assistants, and language-based recommendation systems. However, efficiently implementing such models can be challenging. For example, LLMs are large enough that they no longer fit on a single graphics processing unit (GPU) and require many GPUs for a single inference.

It is with respect to these considerations and others that the disclosure made herein is presented.

### SUMMARY

Disclosed are methods for improving processing and storage efficiencies in large language models (LLMs) while also improving numerical accuracy. The methods may be referred to herein as distribution encoding. The disclosed distribution encoding techniques exploit the non-uniform distribution of model weights to provide improved numerical accuracy and compression, and consequently can reduce the number of GPU's needed for inferencing. This in turn enables the reduction of resources and cost necessary to implement such models.

Other approaches (e.g., Quantization for Generative Pre-trained Transformers (GPTQ), micro-exponents, fine grain scale factors, etc.) attempt to reduce model storage requirements by exploiting model topology or improving the accuracy of outliers. These approaches are effective but ultimately can be considered as two steps:
1. A map of weights to another range where outliers or model inference impact is less of an issue.
2. A round operation

These other methods attempt to optimize step #1, but there are no methods that attempt to optimize step #2. The disclosed distribution encoding techniques optimize the rounding step to preserve more numerical accuracy and can be combined with any quantization algorithms.

Various technical differences and benefits are achieved by the described systems and methods. For example, the presently described systems and methods reduce the number of GPUs required for inferencing, which saves time, operational cycles, and cost.

It should be appreciated that, although described in relation to a method, the above-described subject matter may also be implemented as a system, a computer-controlled apparatus, a computer process, a computing system, or as an article of manufacture such as a computer-readable medium and/or dedicated chipset. These and various other features will be apparent from a reading of the following Detailed Description and a review of the associated drawings. This Summary is provided to introduce a selection of concepts in a simplified form that are further described below in the Detailed Description.

This Summary is not intended to limit the scope of the claimed subject matter. Furthermore, the claimed subject matter is not limited to implementations that solve any or all disadvantages noted in any part of this disclosure.

### DRAWINGS

The Detailed Description is described with reference to the accompanying FIGS. In the FIGS., the left-most digit(s) of a reference number identifies the FIG. in which the reference number first appears. The same reference numbers in different FIGS. indicate similar or identical items.

FIG. 1A is a diagram illustrating an embodiment disclosed herein.

FIG. 1B is a diagram illustrating an embodiment disclosed herein.

FIG. 1C is a diagram illustrating an embodiment disclosed herein.

FIG. 1D is a diagram illustrating an embodiment disclosed herein.

FIG. 2 is a diagram illustrating an example according to an embodiment disclosed herein.

FIG. 3 is a diagram illustrating an example according to an embodiment disclosed herein.

FIG. 4 is a diagram illustrating an example according to an embodiment disclosed herein.

FIG. 5 is a diagram illustrating an example according to an embodiment disclosed herein.

FIG. 6 is a diagram showing aspects of an example system according to an embodiment disclosed herein.

FIG. 7 is a diagram showing aspects of an example system according to an embodiment disclosed herein.

FIG. 8 is a flow diagram showing aspects of an illustrative routine, according to an embodiment disclosed herein.

FIG. 9 is a flow diagram showing aspects of an illustrative routine, according to an embodiment disclosed herein.

FIG. 10 is a flow diagram showing aspects of an illustrative routine, according to an embodiment disclosed herein.

FIG. 11 is a computer architecture diagram illustrating aspects of an example computer architecture for a computer capable of executing the software components described herein.

FIG. 12 is a data architecture diagram showing an illustrative example of a computer environment.

### DETAILED DESCRIPTION

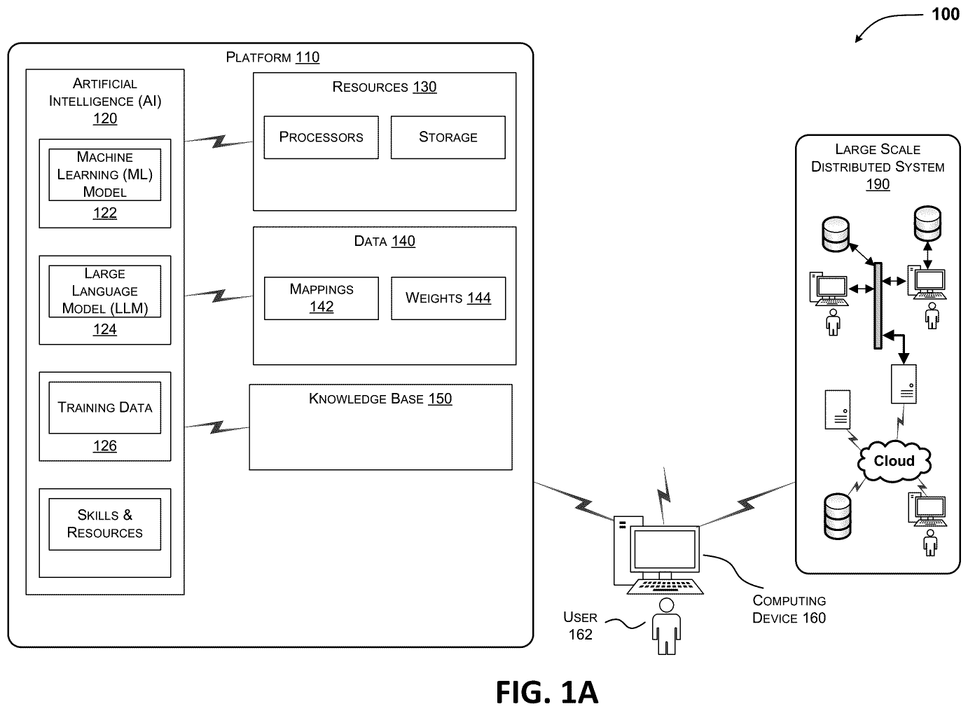

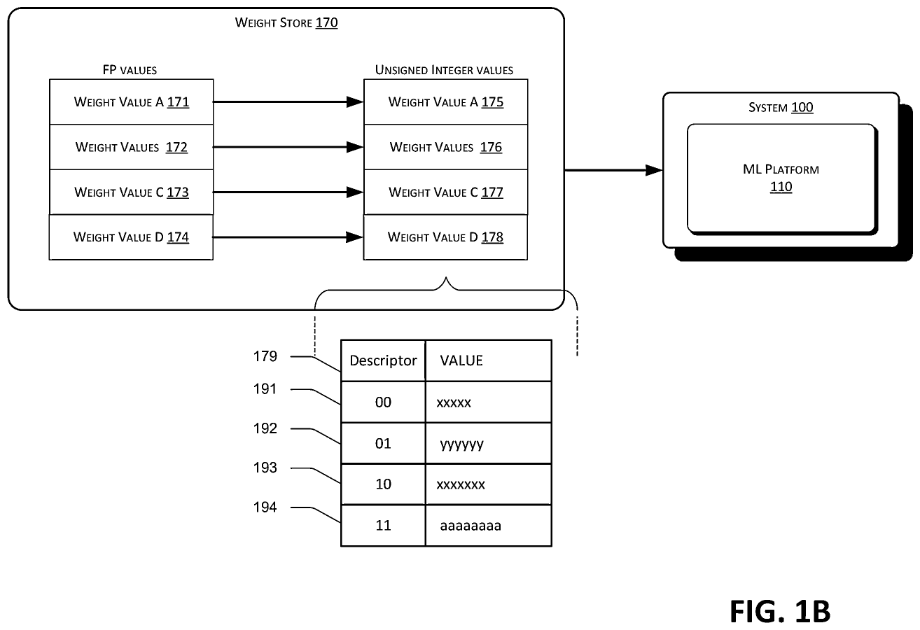

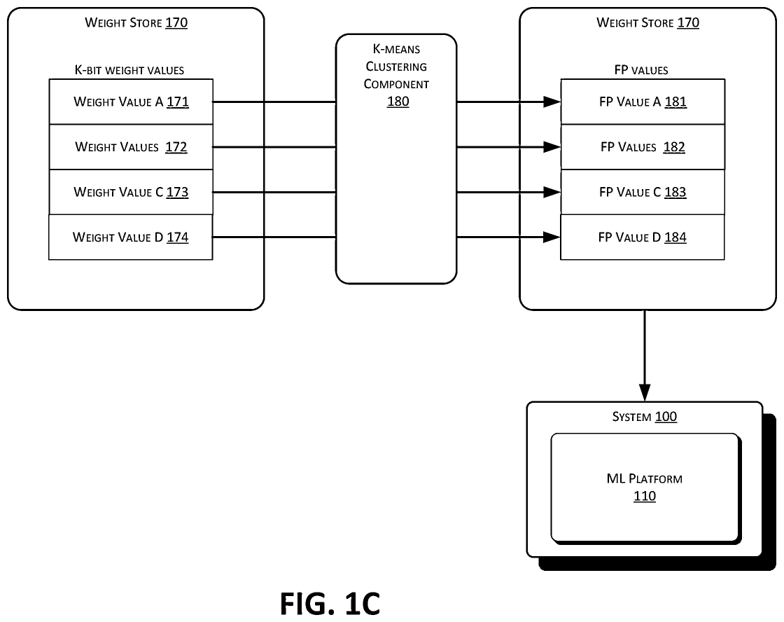

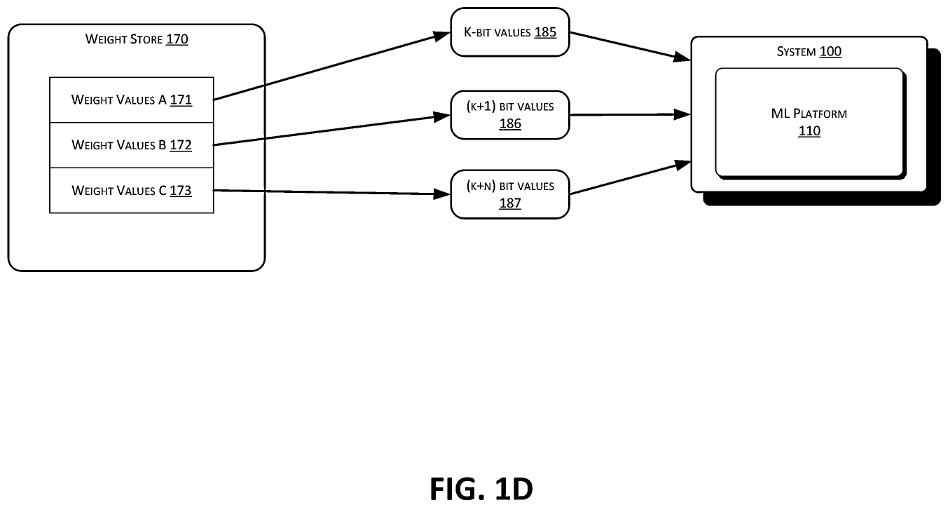

FIG. 1A illustrates an example system 100 that is capable of implementing aspects of the techniques and technologies presented herein. As illustrated, the system 100 may include a platform 110, which includes an artificial intelligence (AI) system or component 120, a resources component 130, a data component 140, and a knowledge base 150.

The platform 110, which may also be referred to herein as a machine learning platform 110, can be interfaced to a large scale distributed system 190, and also to a user 162 via a computing device 160. The AI system or component 120 may include a machine learning (ML) model 122 and/or a large language model (LLM) 124, as well as other skills and resources. AI component 120 is interfaced to the resources component 130, the data component 140 which may include mappings 142 and weights 144, and the knowledge base 150. The AI system or component 120 may include training data 126.

User 162 may operate computing device 160 to navigate a browser to communicate with various tools needed to access the platform 110. In some examples, the user 162 may access a browser to locate monitoring tools, which may monitor system performance and resources used by the large scale distributed system 190. In some additional examples, the user 162 may communicate with the support system via a chatbot type of website that may utilize a natural language model (NLM) interface to interact with users in a human-like way. The AI system or component 120 may be located in a cloud resource, such as on a remote computing device, although it may alternatively be implemented resident on computing device 160.

The AI system or component (or module) 120 may use various natural language processing (NLP) techniques to determine context around keywords and phrases in the text data. One techniques, called contextual word embeddings, represents each word found in a text prompt as a dense, low-dimensional vector that captures meaning in the context of the surrounding words by applying deep learning models, such as using a machine learning model (ML) 122. The LLM 124 in the present AI component 120 can thus be trained on large amounts of text data to learn the patterns and relationships between words and phrases in different contexts. When processing a piece of text data, words and phrases can be context related to their closely related target keyword or phrase in their embeddings by the LLM 124.

The large scale distributed system 190 may include a variety physical and virtual system components, including but not limited to, networking, computing, or data storage resources. Example networking resources in system 190 may include any variety of servers, routers, switches, network controllers, wi-fi access points, including cloud based resources. Example computing resources may include or memory, processors such as CPUs or graphics accelerators, either virtual or physical. Data storage resources may include virtual or physical disk storage, data-base storage, or the like. Users in geographically disparate locations may access system 190 using computing devices such as computing device 160, or cell phones, set-top boxes, tablet computers, etc. Large scale distributed systems may generally be considered as complex computer networks with a large number of distributed resources. Examples of large scale distributed systems may include financial or banking systems, global e-commerce platforms, large scale industrial processes, health care insurance processing systems, to name a few.

Graphics processing units (GPUs) are widely used for deploying large language models based on their parallel processing capabilities and computational power. However, recent large language models can have weights which are too large to fit into a single GPU's memory and must be split across several GPU's. Given that inferencing in large language models is often memory bandwidth bound, a reduction in total GPU memory used can result in a reduction of the total number GPUs needed for these large language models. Alternatively, a reduction of memory could support a larger key-value (KV) cache to allow for more concurrent users.

Efforts to reduce memory usage for large language models have been primarily focused on parameter tuning and quantization to lower bit-count formats. A number of lower bit-count formats have been introduced such as int8, fp8, fp7, fp6, fp5, fp4, int4, and others. Each format has variations where a different number of bits are allocated to the mantissa and exponent. There are further variations that involve the use of micro-exponents in approaches such as those used in Microsoft Floating Point (MSFP), fine grain weight scale values, or different approaches to quantization such as Quantization for Generative Pre-trained Transformers (GPTQ). However, such formats do not optimally represent the weights and either waste bits of storage or fail to increase precision.

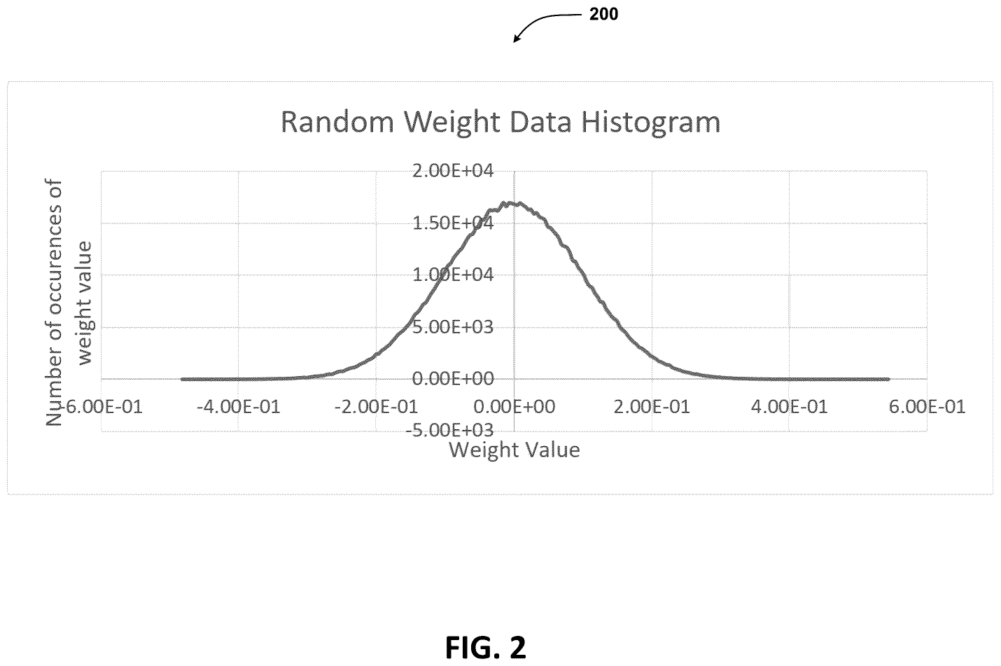

The present disclosure includes improvements relating to the nonuniformity of weights, including lossless compression and improved accuracy. For distribution weights of various existing models, it is observed that the weight histograms are not uniformly distributed, and the weight histograms are slightly different for different weights. An example random normal distribution of weights 200 is shown in FIG. 2.

The disclosed embodiments are compatible with other methods, including fine grain scale factors, micro-exponents, and GPTQ. Additional embodiments described herein can potentially render some of the previous techniques unnecessary.

In an embodiment a lossless compression method is described that enables more efficient and faster processing. In cases where weight histograms deviate from uniform distributions, lossless GPU memory compression can be implemented. The benefits of lossless GPU memory compression include reduced memory usage and faster model inferencing. Additionally, the lossless aspect does not require model validation since weights are verifiably identical.

Many lossless compression schemes are possible; however, to avoid speed impacts on inferencing and allowing for improved speed, decompression should be available inline with existing Compute Unified Device Architecture (CUDA) kernels and fast enough to retain GPU memory bandwidth bounds.

In an embodiment, techniques for implementing lossless compression in a machine learning model are illustrated in FIG. 1B. 8-bit fp8 weight values 171, 172, 173, and 174 are stored in weight store 170. The 8-bit fp8 weight values are mapped to unsigned 8-bit integers 175, 176, 177, and 178. In an embodiment, the most frequently occurring fp8 values are mapped to the lowest unsigned 8-bit integer weight values. It can be appreciated that 8-bit fp8 weight values are an example and that other weight values with different numbers of bits and different fp values can be used.

In an embodiment, a grouping or number of fp8 weight values is selected. For example, every four fp8 weight values can be selected. Other numbers of weight values may be selected. In an embodiment, for every four fp8 weight values, a 2-bit descriptor 179 is selected that indicates whether the associated four fp8 weight values are stored as 5-bit, 6-bit, 7-bit, or 8-bit. For example, descriptor 191 is ‘00’ which indicates a 5-bit value; descriptor 192 is ‘01’ which indicates a 6-bit value; descriptor 193 is ‘10’ which indicates a 7-bit value; and descriptor 194 is ‘11’ which indicates a 8-bit value. More generally, the descriptor 191 can have other numbers of bits depending on the implementation and the bit-numbers that need to be represented by the descriptor 191.

The four fp8 weight values are stored in weight store 170 based on the 2-bit descriptor 179. The stored fp8 weight values are used for inferencing using the machine learning model.

In an embodiment, a compression scheme that achieves CUDA speed objectives is provided below.
Map the 8-bit fp8 values to another unsigned 8-bit integer where the most frequently occurring values map to the lowest values.
   This mapping causes several of the most significant bits to frequently be zeros.
   The zeros in the most significant bits do not need to be stored when they occur.
   This mapping is invertible for rapid decompression.
For every four fp8 weights, add a 2-bit descriptor that indicates if the following (or associated) four weights are each stored as 5-bit, 6-bit, 7-bit, or 8-bit values.
The number of weights in a group is determined as a balance between descriptor overhead and the probability that all entries have zero in their most significant bits. If the groups have too few elements, then the descriptor storage overhead is too high and if the groups have too many elements, then the probability of all elements having zeros in their most significant bits decreases.

The disclosed techniques for implementing lossless compression use less memory and enable faster weight access time. The disclosed compression method can be combined with other approaches that are lossy which provide further improvements as discussed herein.

In the embodiments described above, it was shown that lossless compression can be implemented if the bit representations of weights are not uniformly distributed in the weight histogram. In further embodiments, an encoding is described that maps k-bit values to a higher precision floating point number in order to minimize the error between the encoded k-bit values and the original weights that are output from training. This allows for a bit encoding that matches the weight distribution more precisely than generic floating point/integer formats. A more precise encoding enables the storing of fewer encoded bits or improved accuracy. The k-bit numeric encoding that minimizes L2 error is referred to herein as a k-bit distribution encoding.

In an embodiment, the optimal k-means clustering algorithm is used to compute a mapping from k-bits to fp16 values. “Ckmeans.1d.dp: Optimal k-means Clustering in One Dimension by Dynamic Programming” (The R Journal Vol. 3/2, December 2011) provides one example algorithm that can be implemented.

In an embodiment, FIG. 1C illustrates techniques for implementing a machine learning model 110 running on system 100. A k-means clustering component 180 is used to map k-bit weight values 171, 172, 173, and 174 in weight store 170 to floating point values 181, 182, 183, and 184. The mapped floating point weight values are stored in weight store 170. The stored floating point weight values 181, 182, 183, and 184 are used for inferencing using the machine learning model implemented on platform 110. This minimizes error between encoded k-bit values and original weights that are output from training of the machine learning model implemented on platform 110.

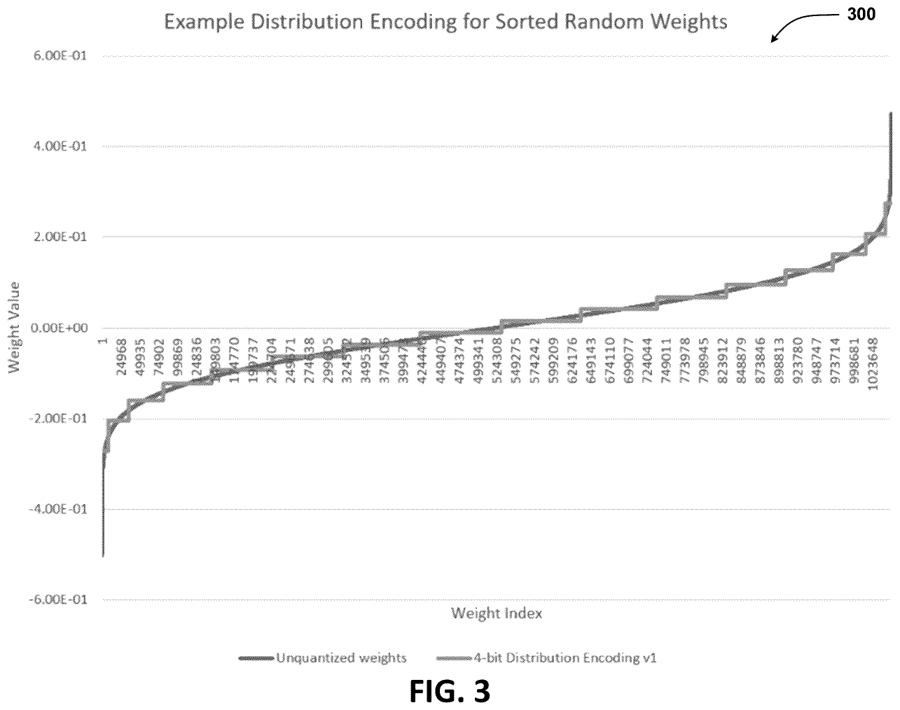

An example of the values chosen for a 4-bit distribution encoding from the sorted fp16 weights of a large random distribution 300 is shown in FIG. 3 to provide an example visualization for distribution encoding. In the example shown in FIG. 3, 1,000,000 weights from a model are sorted and the 4-bit distribution encoding is computed and illustrated as an overlay. FIG. 3 illustrates how the values track the distribution adaptively and are close to the actual values. Referring to FIG. 3, the x-axis=index after weights were sorted by magnitude, and y-axis=fp16 weight value. For 4-bit/5-bit/6-bit/7-bit/8-bit formats, the disclosed distribution encoding techniques produce approximately 1.5× less L2 error than the corresponding floating point encodings.

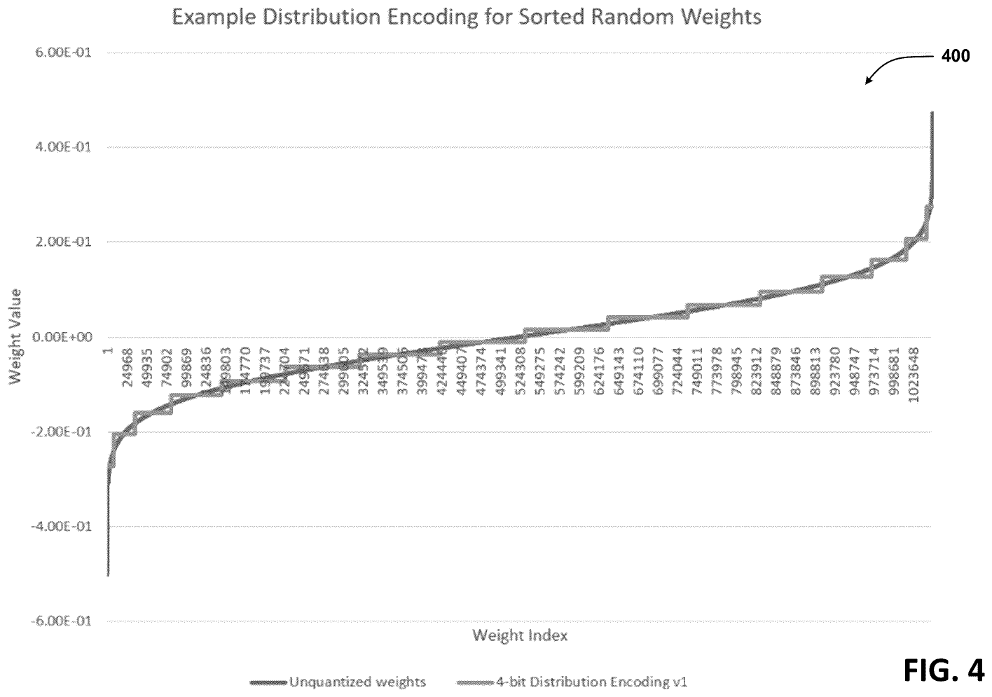

When bit-depths reduce to 4-bits, with only 16-unique values there are several numerical precision problems that affect multiply operations. This can be observed from the distribution graph showing the resulting values, as illustrated in the distribution graph 400 in FIG. 4. The full range of values is not expressible, resulting in truncation of some of the larger values. Most values occur near zero, but much of the error results from the larger values further from zero. Additionally, there is a fundamental tradeoff between how far large weights are from zero and the precision maintained near zero.

Approaches that have been used to mitigate these issues for low bit-rate formats include fine grain scale factors, micro-exponents, etc. These methods attempt to regain some of the dynamic range of weight values while still maintaining the precision near zero most of the time. However, existing approaches for providing scale factors exhibit the issue that the scale factors are not entirely independent with weights. Thus, a large value could reduce the precisions of nearby weights. For example, in the simple case of a micro-exponent where an exponent bit is shared between two values, if one value is large, then the other value loses precision. Alternatively, if a scale factor is stored every 64 weights, then one large weight value causes the other 63 weights to lose precision.

The disclosed embodiments provide a distribution decoding technique that avoids the described dependency issues, allows each weight to be truly independent, and enables precision near zero as well as for large values.

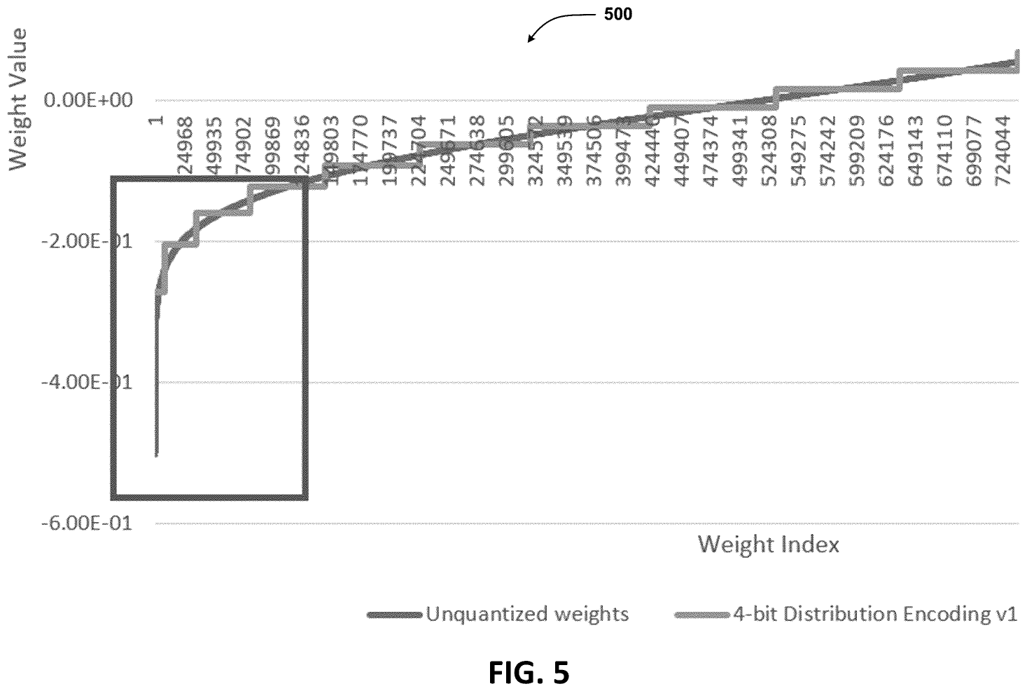

For 4-bit distribution encodings, it can be observed that some of the 16 values for weights far from zero only have a small number of weights in that range which is exploited by property scale vectors/micro-exponents, as shown in the example distribution 500 in FIG. 5.

In an embodiment, one way to exploit large weights that occur infrequently is to implement different numbers of bits for different ranges of values. Since the values further from zero tend to be infrequent, using more bits for such cases only slightly increases the storage requirements.

In an embodiment, FIG. 1D illustrates techniques for encoding values in a machine learning model. Referring to FIG. 1D, a base encoding depth k is selected for encoding weight values 171, 172, 173 for the machine learning model 110. At least some possible k-bit values 185 are selected to have (k+1)-bit values 186. Weight values having depth k 185 and other weight values having depth k+1 186 are stored. In some embodiments, weight values having depth k+N 187 are stored. The stored weight values are used for inferencing using the machine learning model 110. This enables weight independence and greater precision near zero and for large values.

In an embodiment, a method for variable bitrate distribution encoding includes:
1. Select a base encoding depth, e.g., 4-bit.
2. Of the 16 possible values for the base 4-bit, some number of those values are selected to have 5-bit values.
3. Of all the 5-bit encoded values, some of those values may be selected to have 6-bit encoded values
4. This progression of variable bits can continue arbitrarily, but at some point, improvements become marginal and it may not be cost effective to provide additional bit formats.

In an embodiment, determination of which values are encoded as 4-bit/5-bit/6-bit/etc. can be performed with each bit-value optimized with optimal k-means clustering.

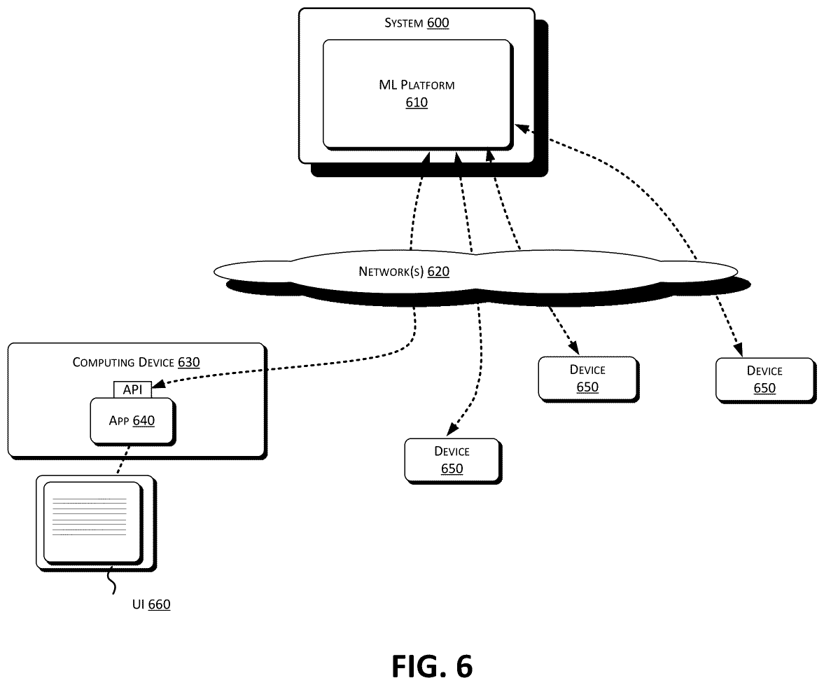

In the example system illustrated in FIG. 6, a system 600 is illustrated that implements a ML platform 610. The ML platform 610 is configured to provide output data to various devices 650 over a network 620, as well as computing device 630. A user interface 660 is rendered on computing device 630. The user interface 660 is provided in conjunction with an application 640 that communicates to the ML platform 610 using an API via network 620. In some embodiments, system 600 is configured to provide information to users. In one example, system 600 runs a ML platform 610 to perform one or more tasks. The ML platform 610 utilizes the ML system to perform tasks such as image recognition. The ML platform 610 is configured to be optimized using the techniques described herein.

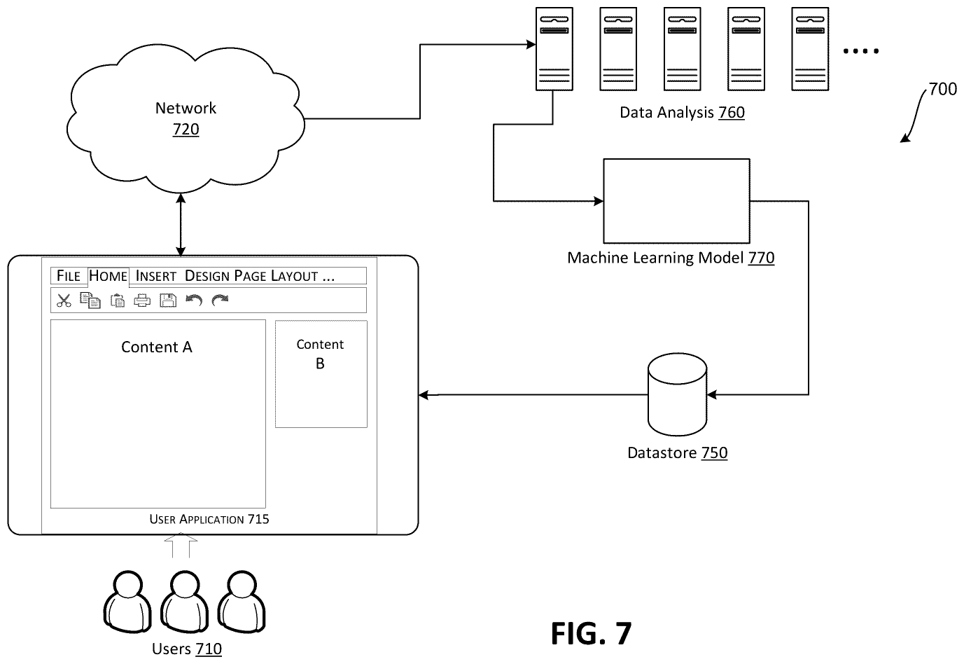

FIG. 7 is a computing system architecture diagram showing an overview of another system disclosed herein for implementing a machine learning model, according to one embodiment disclosed herein. As shown in FIG. 7, a ML system 700 is illustrated that shows further detail to system 600 shown in FIG. 6. ML system 700 is configured to perform analysis and perform identification, prediction, or other functions based upon various data collected by and processed by data analysis components 760 (which can be referred to individually as an “data analysis component 760” or collectively as the “data analysis components 760”). The data analysis components 760, for example, includes physical computing devices such as server computers or other types of hosts, associated hardware components (e.g., memory and mass storage devices), and networking components (e.g., routers, switches, and cables) communicating over a network 720. The data analysis components 760 can also include software, such as operating systems, applications, containers, network services, and virtual components, such as virtual disks, virtual networks, and virtual machines. The datastore 750 can include data, such as a database, or a database shard (i.e., a partition of a database). Feedback is used to further update various parameters that are used by machine learning model 770. Data is provided to the user application 715, which can be used to provide results to various users 710. In some configurations, machine learning model 770 is configured to utilize supervised and/or unsupervised machine learning technologies.

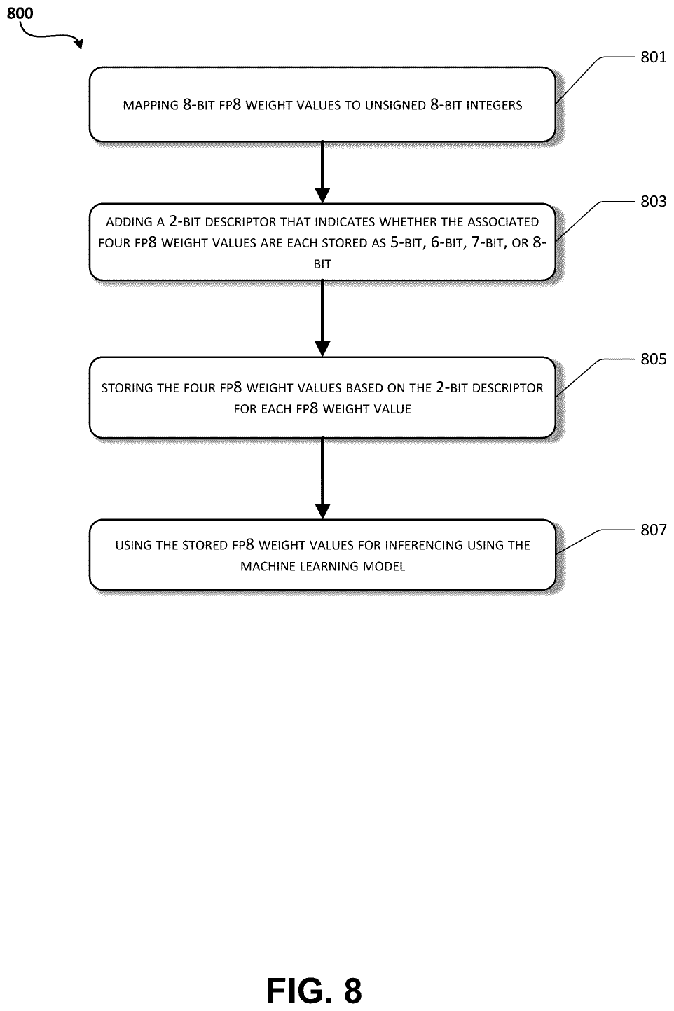

Turning now to FIG. 8, illustrated is an example operational procedure 800 in accordance with the present disclosure. The operational procedure can be implemented in a system comprising one or more computing devices.

It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Referring to FIG. 8, operation 801 illustrates mapping 8-bit fp8 weight values to unsigned 8-bit integers, wherein most frequently occurring fp8 values map to lowest unsigned 8-bit integer weight values.

Operation 803 illustrates for every four fp8 weight values: adding a 2-bit descriptor that indicates whether the associated four fp8 weight values are stored as 5-bit, 6-bit, 7-bit, or 8-bit.

Operation 805 illustrates for every four fp8 weight values: storing the four fp8 weight values based on the 2-bit descriptor.

Operation 807 illustrates using the stored fp8 weight values for inferencing using the machine learning model.

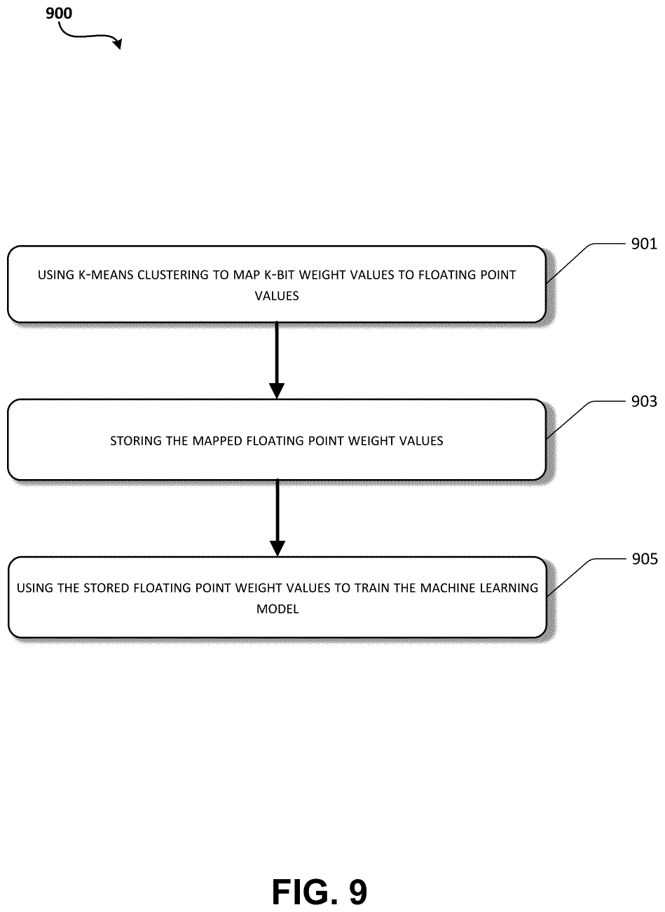

Referring to FIG. 9, procedure 900 includes operation 901 which illustrates using k-means clustering to map k-bit weight values to floating point values. Operation 903 illustrates storing the mapped floating point weight values. Operation 905 illustrates using the stored floating point weight values for inferencing using the machine learning model. In an embodiment, this allows minimizing error between encoded k-bit values and original weights that are output from training of the machine learning model.

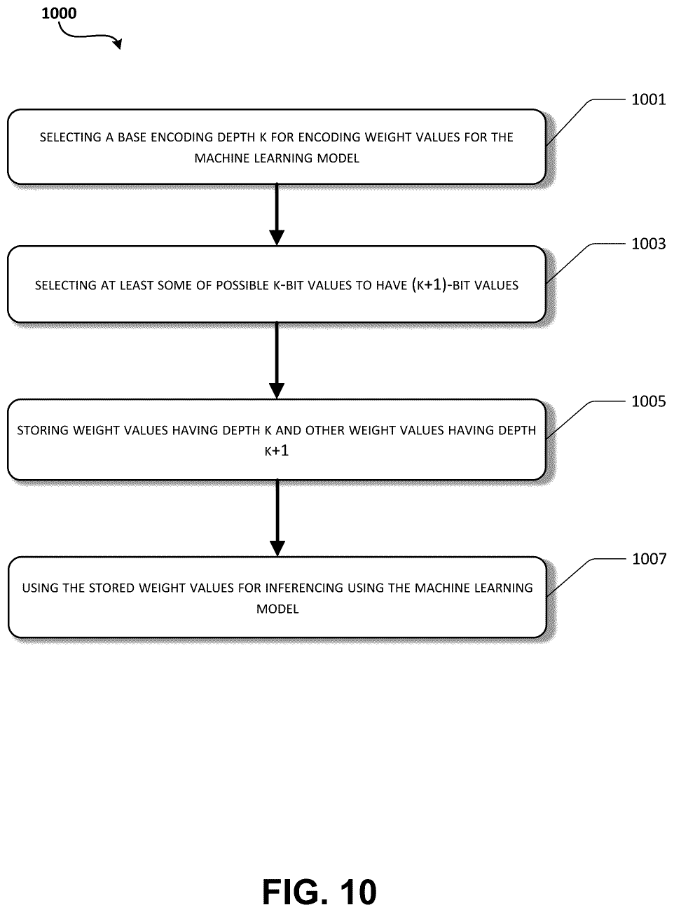

Referring to FIG. 10, procedure 1000 includes operation 1001 which illustrates selecting a base encoding depth k for encoding weight values for the machine learning model. Operation 1003 illustrates selecting at least some of possible k-bit values to have (k+1)-bit values.

Operation 1005 illustrates storing weight values having depth k and other weight values having depth k+1. Operation 1007 illustrates using the stored weight values for inferencing using the machine learning model. This enables weight independence and greater precision near zero and for large values.

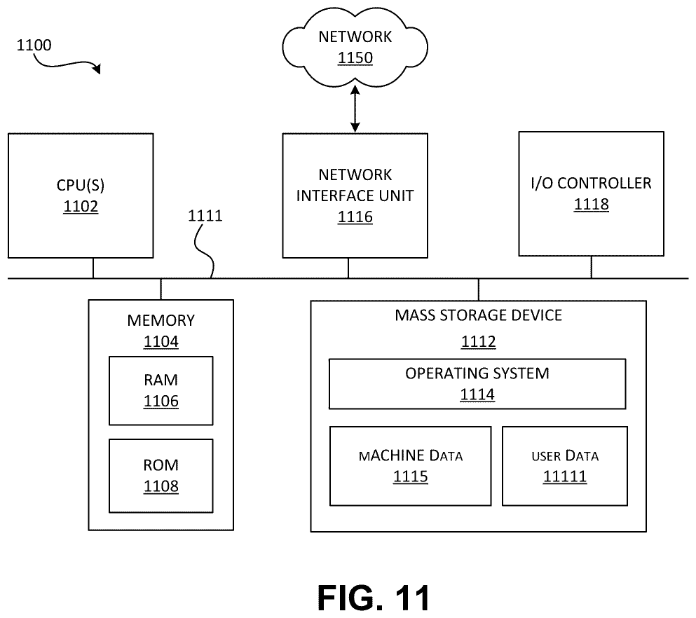

FIG. 11 shows an example computer architecture for a computer capable of providing the functionality described herein such as, for example, a computing device configured to implement the functionality described above with reference to FIGS. 1-6. Thus, the computer architecture 1100 illustrated in FIG. 11 illustrates an architecture for a server computer or another type of computing device suitable for implementing the functionality described herein. The computer architecture 1100 might be utilized to execute the various software components presented herein to implement the disclosed technologies.

The computer architecture 1100 illustrated in FIG. 11 includes a central processing unit 1102 (“CPU”), a system memory 1104, including a random-access memory 1106 (“RAM”) and a read-only memory (“ROM”) 1108, and a bus 1111 that couples the memory 1104 to the CPU 1102. A firmware containing basic routines that help to transfer information between elements within the computer architecture 1100, such as during startup, is stored in the ROM 1108. The computer architecture 1100 further includes a mass storage device 1112 for storing an operating system 1114, other data, such as product data 1115 or user data 11111.

The mass storage device 1112 is connected to the CPU 1102 through a mass storage controller (not shown) connected to the bus 1111. The mass storage device 1112 and its associated computer-readable media provide non-volatile storage for the computer architecture 1100. Although the description of computer-readable media contained herein refers to a mass storage device, such as a solid-state drive, a hard disk or optical drive, it should be appreciated by those skilled in the art that computer-readable media can be any available computer storage media or communication media that can be accessed by the computer architecture 1100.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, communication media includes wired media such as a wired network or direct-wired connection, and wireless media such as acoustic, radio frequency, infrared and other wireless media. Combinations of the any of the above should also be included within the scope of computer-readable media.

By way of example computer-readable storage media might include volatile and non-volatile, removable and non-removable media implemented in any method or technology for storage of information such as computer-readable instructions, data structures, program modules or other data. For example, computer media includes RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1100. For purposes of the claims, the phrase “computer storage medium,” “computer-readable storage medium” and variations thereof, does not include waves, signals, and/or other transitory and/or intangible communication media, per se.

According to various implementations, the computer architecture 1100 might operate in a networked environment using logical connections to remote computers through a network 1150 and/or another network (not shown). A computing device implementing the computer architecture 1100 might connect to the network 1150 through a network interface unit 1116 connected to the bus 1111. It should be appreciated that the network interface unit 1116 might also be utilized to connect to other types of networks and remote computer systems.

The computer architecture 1100 might also include an input/output controller 1118 for receiving and processing input from a number of other devices, including a keyboard, mouse, or electronic stylus (not shown in FIG. 11). Similarly, the input/output controller 1118 might provide output to a display screen, a printer, or other type of output device (also not shown in FIG. 11).

It should be appreciated that the software components described herein might, when loaded into the CPU 1102 and executed, transform the CPU 1102 and the overall computer architecture 1100 from a general-purpose computing system into a special-purpose computing system customized to facilitate the functionality presented herein. The CPU 1102 might be constructed from any number of transistors or other discrete circuit elements, which might individually or collectively assume any number of states. More specifically, the CPU 1102 might operate as a finite-state machine, in response to executable instructions contained within the software modules disclosed herein. These computer-executable instructions might transform the CPU 1102 by specifying how the CPU 1102 transitions between states, thereby transforming the transistors or other discrete hardware elements constituting the CPU 1102.

Encoding the software modules presented herein might also transform the physical structure of the computer-readable media presented herein. The specific transformation of physical structure might depend on various factors, in different implementations of this description. Examples of such factors might include the technology used to implement the computer-readable media, whether the computer-readable media is characterized as primary or secondary storage, and the like. If the computer-readable media is implemented as semiconductor-based memory, the software disclosed herein might be encoded on the computer-readable media by transforming the physical state of the semiconductor memory. For example, the software might transform the state of transistors, capacitors, or other discrete circuit elements constituting the semiconductor memory. The software might also transform the physical state of such components in order to store data thereupon.

As another example, the computer-readable media disclosed herein might be implemented using magnetic or optical technology. In such implementations, the software presented herein might transform the physical state of magnetic or optical media, when the software is encoded therein. These transformations might include altering the magnetic characteristics of locations within given magnetic media. These transformations might also include altering the physical features or characteristics of locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1100 in order to store and execute the software components presented herein. It also should be appreciated that the computer architecture 1100 might include other types of computing devices, including hand-held computers, embedded computer systems, personal digital assistants, and other types of computing devices known to those skilled in the art.

It is also contemplated that the computer architecture 1100 might not include all of the components shown in FIG. 11, might include other components that are not explicitly shown in FIG. 11, or might utilize an architecture completely different than that shown in FIG. 11. For example, the technologies disclosed herein can be utilized with multiple CPUS for improved performance through parallelization, graphics processing units (“GPUs”) for faster computation, and/or tensor processing units (“TPUs”). The term “processor” as used herein encompasses CPUs, GPUs, TPUs, and other types of processors.

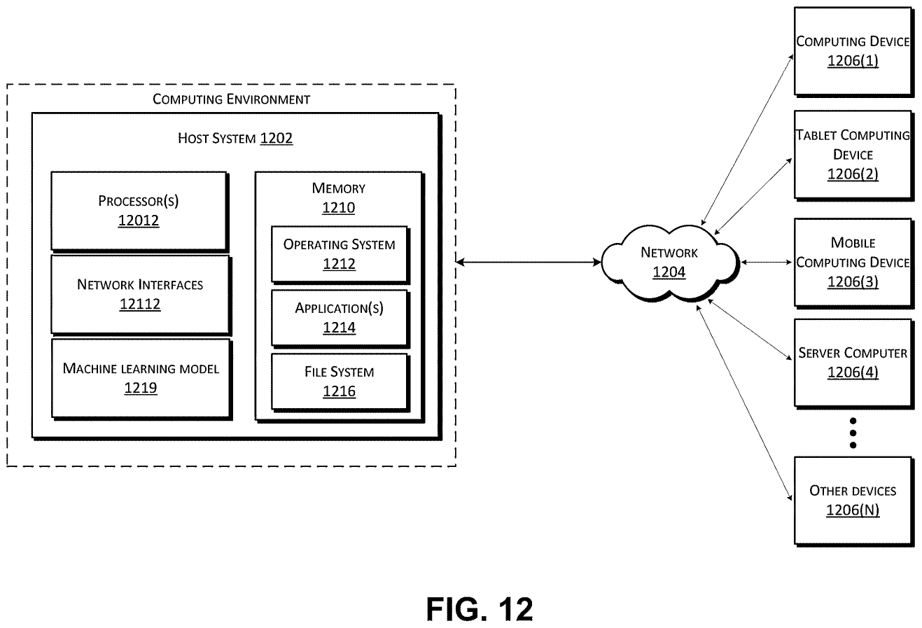

FIG. 12 illustrates an example computing environment capable of executing the techniques and processes described above with respect to FIGS. 1-7. In various examples, the computing environment comprises a host system 1202. In various examples, the host system 1202 operates on, in communication with, or as part of a network 1204.

The network 1204 can be or can include various access networks. For example, one or more client devices 1206(1) . . . 1206(N) can communicate with the host system 1202 via the network 1204 and/or other connections. The host system 1202 and/or client devices can include any one of a variety of devices, including portable devices or stationary devices such as a server computer, a smart phone, a mobile phone, a personal digital assistant (PDA), an electronic book device, a laptop computer, a desktop computer, a tablet computer, a portable computer, a gaming console, a personal media player device, or any other electronic device.

According to various implementations, the functionality of the host system 1202 can be provided by one or more servers that are executing as part of, or in communication with, the network 1204. A server can host various services, virtual machines, portals, and/or other resources. For example, a can host or provide access to one or more portals, Web sites, and/or other information.

The host system 1202 can include a processing system comprising processor(s) 12012 memory 1210. The memory 1210 can comprise an operating system 1212, application(s) 1214, and/or a file system 1216.

The processor(s) 12012 can be a single processing unit or a number of units, each of which could include multiple different processing units. The processor(s) can include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), other logic circuitry, a system on chip (SoC), and/or any other devices that perform operations based on instructions. Among other capabilities, the processor(s) may be configured to fetch and execute computer-readable instructions stored in the memory 1210.

The memory 1210 can include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes phase change memory (PCM), static random-access memory (SRAM), dynamic random-access memory (DRAM), other types of random-access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

The host system 1202 can communicate over the network 1204 via network interfaces 12112. The network interfaces 12112 can include various types of network hardware and software for supporting communications between two or more devices. The host system 1202 may also include machine learning model 1219.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method for implementing lossless compression in a machine learning model, the method comprising:
mapping 8-bit fp8 weight values to unsigned 8-bit integers, wherein most frequently occurring fp8 values map to lowest unsigned 8-bit integer weight values;
for every four fp8 weight values;
adding a 2-bit descriptor that indicates whether the associated four fp8 weight values are stored as 5-bit, 6-bit, 7-bit, or 8-bit; and
storing the four fp8 weight values based on the 2-bit descriptor; and
using the stored fp8 weight values for inferencing using the machine learning model.

Clause 2: The method of clause 1, wherein the machine learning model is a large language model.

Clause 3: The method of any of clauses 1-2, wherein zeros in most significant bits are not stored.

Clause 4: The method of any of clauses 1-3, wherein bit representations of the weight values are not uniformly distributed in a histogram of the weight values.

Clause 5: The method of any of clauses 1-4, wherein the lossless compression is implemented inline with Compute Unified Device Architecture (CUDA) kernels.

Clause 6: The method of any of clauses 1-5, further comprising inverting the mapping.

Clause 7: The method of clauses 1-6, further comprising:
using k-means clustering to map k-bit weight values to floating point values;
storing the mapped floating point weight values; and
using the stored floating point weight values for inferencing using the machine learning model;
thereby minimizing error between encoded k-bit values and original weights that are output from training.

Clause 8: The method of any of clauses 1-7, further comprising:
selecting a base encoding depth k for encoding weight values for the machine learning;
selecting at least some of possible k-bit values to have (k+1)-bit values;
storing weight values having depth k and other weight values having depth k+1; and
using the stored weight values for inferencing using the machine learning model;
thereby enabling weight independence and greater precision near zero and for large values.

Clause 9: A computing system comprising:
a processing system comprising a processor; and
computer-readable media having thereon computer-executable instructions that are structured such that, when executed by the processing system, cause the computing system to perform operations comprising:
mapping 8-bit fp8 weight values to unsigned 8-bit integers, wherein most frequently occurring fp8 values map to lowest unsigned 8-bit integer weight values;
for every four fp8 weight values:
adding a 2-bit descriptor that indicates whether the associated four fp8 weight values are each stored as 5-bit, 6-bit, 7-bit, or 8-bit; and
storing the four fp8 weight values based on the 2-bit descriptor for each fp8 weight value; and
using the stored fp8 weight values for inferencing using a machine learning model.

Clause 10: The system of clause 9, wherein the machine learning model is a large language model.

Clause 11: The system of any of clauses 9 and 10, wherein zeros in most significant bits are not stored.

Clause 12: The system of any of clauses 9-11, wherein bit representations of the weight values are not uniformly distributed in a histogram of the weight values.

Clause 13: The system of any of clauses 9-12, wherein lossless compression is implemented inline with Compute Unified Device Architecture (CUDA) kernels.

Clause 14: The system of any clauses of 9-13, further comprising inverting the mapping.

Clause 15: A computer-readable storage medium having computer-executable instructions stored thereupon which, when executed by one or more processors of a system, cause the system to perform operations comprising:
mapping 8-bit fp8 weight values to unsigned 8-bit integers, wherein most frequently occurring fp8 values map to lowest unsigned 8-bit integer weight values;
for every four fp8 weight values:
adding a 2-bit descriptor that indicates whether the associated four fp8 weight values are each stored as 5-bit, 6-bit, 7-bit, or 8-bit; and
storing the four fp8 weight values based on the 2-bit descriptor for each fp8 weight value; and
using the stored fp8 weight values for inferencing using a machine learning model.

Clause 16: The computer-readable storage medium of clause 15, wherein the machine learning model is a large language model.

Clause 17: The computer-readable storage medium of clauses 15 and 16, wherein zeros in most significant bits are not stored.

Clause 18: The computer-readable storage medium of clauses 15-17, wherein bit representations of the weight values are not uniformly distributed in a histogram of the weight values.

Clause 19: The computer-readable storage medium of clauses 15-18, further comprising computer-executable instructions that are structured such that, when executed by a processing system of a computing system, cause the computing system to perform operations comprising:
using k-means clustering to map k-bit weight values to floating point values;
storing the mapped floating point weight values; and
using the stored floating point weight values for inferencing the machine learning;
thereby minimizing error between encoded k-bit values and original weights that are output from training.

Clause 20: The computer-readable storage medium of clauses 15-19, further comprising computer-executable instructions that are structured such that, when executed by a processing system of a computing system, cause the computing system to perform operations comprising:
selecting a base encoding depth k for encoding weight values for the machine learning model;
selecting at least some of possible k-bit values to have (k+1)-bit values;
storing weight values having depth k and other weight values having depth k+1; and
using the stored weight values for inferencing using the machine learning model;
thereby enabling weight independence and greater precision near zero and for large values.

The disclosure presented herein also encompasses the subject matter set forth in the following additional clauses:

Clause 21: A method for implementing a machine learning model, the method comprising:
using k-means clustering to map k-bit weight values to floating point values;
storing the mapped floating point weight values; and
using the stored floating point weight values for inferencing using the machine learning model;
thereby minimizing error between encoded k-bit values and original weights that are output from training of the machine learning model.

Clause 22: The method of clause 21, wherein the machine learning model is a large language model.

Clause 23: The method of any of clauses 21-22, wherein the error is L2 error.

Clause 24: The method of any of clauses 21-23, further comprising modifying the k-bit weight values using a scale vector or bias vector present for each k weight values.

Clause 25: The method of any of clauses 21-24, wherein the k-means clustering is performed using an algorithm that guarantees optimality in one-dimensional space.

Clause 22: The method of any of clauses 21-25, wherein the k-bit weight values are implemented as 4-bit, 5-bit, 6-bit, 7-bit, or 8-bit formats.

Clause 27: The method of clauses 21-26, wherein the k-bit weight values are implemented as 8-bit format, the method further comprising:
mapping 8-bit fp8 weight values to unsigned 8-bit integers, wherein most frequently occurring fp8 values map to lowest unsigned 8-bit integer weight values;
for every four fp8 weight values:
adding a 2-bit descriptor that indicates whether the associated four fp8 weight values are each stored as 5-bit, 6-bit, 7-bit, or 8-bit; and
storing the four fp8 weight values based on the 2-bit descriptor for each fp8 weight value; and
using the stored fp8 weight values for inferencing using the machine learning model.

Clause 28: A method for encoding values in a machine learning model, the method comprising:
selecting a base encoding depth k for encoding weight values for the machine learning model;
selecting at least some of possible k-bit values to have (k+1)-bit values;
storing weight values having depth k and other weight values having depth k+1; and
using the stored weight values for inferencing using the machine learning model;
thereby enabling weight independence and greater precision near zero and for large values.

Clause 29: The method of clause 28, wherein the machine learning model is a large language model.

Clause 30: The method of any of clauses 28 and 29, further comprising selecting some of possible (k+1)-bit values to have (k+2)-bit values.

Clause 31: The method of any of clauses 28-30, further comprising optimizing the selection of which weight values are encoded as (k+1)-bit values or (k+2)-bit values using k-means clustering.

Clause 32: The method of any of clauses 28-31, further comprising implementing lossless compression.

Clause 33: The method of any of clauses 28-32, wherein the lossless compression is implemented by:
using k-means clustering to map k-bit weight values to floating point values;
storing the mapped floating point weight values; and
using the stored floating point weight values for inferencing using the machine learning model;
thereby minimizing error between encoded k-bit values and original weights that are output from training of the machine learning model.

Clause 34: A computing system comprising:
a processing system comprising a processor; and
computer-readable media having thereon computer-executable instructions that are structured such that, when executed by the processing system, cause the computing system to perform operations comprising:
using k-means clustering to map k-bit weight values to floating point values; storing the mapped floating point weight values; and using the stored floating point weight values for inferencing using a machine learning model;
thereby minimizing error between encoded k-bit values and original weights that are output from training of the machine learning model.

Clause 35: The computing system of clause 34, wherein the machine learning model is a large language model.

Clause 36: The computing system of any of clauses 34 and 35, wherein the error is L2 error.

Clause 37: The computing system of any of clauses 34-36, further comprising computer-readable media having thereon computer-executable instructions that are structured such that, when executed by the processing system, cause the computing system to perform operations comprising modifying the k-bit weight values using a scale vector or bias vector present for each k weight values.

Clause 38: The computing system of any of clauses 34-37, wherein the k-means clustering is performed using an algorithm that guarantees optimality in one-dimensional space.

Clause 39: The computing system of any of clauses 34-38, wherein the k-bit weight values are implemented as 4-bit, 5-bit, 6-bit, 7-bit, or 8-bit formats.

Clause 40: The computing system of any of clauses 34-39, wherein the k-bit weight values are implemented as 8-bit format, further comprising computer-readable media having thereon computer-executable instructions that are structured such that, when executed by the processing system, cause the computing system to perform operations comprising:
mapping 8-bit fp8 weight values to unsigned 8-bit integers, wherein most frequently occurring fp8 values map to lowest unsigned 8-bit integer weight values;
for every four fp8 weight values:
adding a 2-bit descriptor that indicates whether the associated four fp8 weight values are each stored as 5-bit, 6-bit, 7-bit, or 8-bit; and
storing the four fp8 weight values based on the 2-bit descriptor for each fp8 weight value; and
using the stored fp8 weight values for inferencing using the machine learning model.

What is claimed is:

1. A method for implementing lossless compression in a machine learning model, the method comprising:
mapping 8-bit fp8 weight values to unsigned 8-bit integers, wherein most frequently occurring fp8 values map to lowest unsigned 8-bit integer weight values;
for every four fp8 weight values:
adding a 2-bit descriptor that indicates whether the associated four fp8 weight values are stored as 5-bit, 6-bit, 7-bit, or 8-bit; and
storing the four fp8 weight values based on the 2-bit descriptor; and
using the stored fp8 weight values for inferencing using the machine learning model.

2. The method of claim 1, wherein the machine learning model is a large language model.

3. The method of claim 1, wherein zeros in most significant bits are not stored.

4. The method of claim 1, wherein bit representations of the weight values are not uniformly distributed in a histogram of the weight values.

5. The method of claim 1, wherein the lossless compression is implemented inline with Compute Unified Device Architecture (CUDA) kernels.

6. The method of claim 1, further comprising inverting the mapping.

7. The method of claim 1, further comprising:
using k-means clustering to map k-bit weight values to floating point values;
storing the mapped floating point weight values; and
using the stored floating point weight values for inferencing using the machine learning model;
thereby minimizing error between encoded k-bit values and original weights that are output from training.

8. The method of claim 1, further comprising:
selecting a base encoding depth k for encoding weight values for the machine learning;
selecting at least some of possible k-bit values to have (k+1)-bit values;
storing weight values having depth k and other weight values having depth k+1; and
using the stored weight values for inferencing using the machine learning model;
thereby enabling weight independence and greater precision near zero and for large values.

9. A computing system comprising:
a processing system comprising a processor; and
computer-readable media having thereon computer-executable instructions that are structured such that, when executed by the processing system, cause the computing system to perform operations comprising:
mapping 8-bit fp8 weight values to unsigned 8-bit integers, wherein most frequently occurring fp8 values map to lowest unsigned 8-bit integer weight values;
for every four fp8 weight values:
adding a 2-bit descriptor that indicates whether the associated four fp8 weight values are each stored as 5-bit, 6-bit, 7-bit, or 8-bit; and
storing the four fp8 weight values based on the 2-bit descriptor for each fp8 weight value; and
using the stored fp8 weight values for inferencing using a machine learning model.

10. The computing system of claim 9, wherein the machine learning model is a large language model.

11. The computing system of claim 9, wherein zeros in most significant bits are not stored.

12. The computing system of claim 9, wherein bit representations of the weight values are not uniformly distributed in a histogram of the weight values.

13. The computing system of claim 9, wherein lossless compression is implemented inline with Compute Unified Device Architecture (CUDA) kernels.

14. The computing system of claim 9, further comprising inverting the mapping.

15. A computer-readable storage medium having thereon computer-executable instructions that are structured such that, when executed by a processing system of a computing system, cause the computing system to perform operations comprising:
mapping 8-bit fp8 weight values to unsigned 8-bit integers, wherein most frequently occurring fp8 values map to lowest unsigned 8-bit integer weight values;
for every four fp8 weight values:
adding a 2-bit descriptor that indicates whether the associated four fp8 weight values are each stored as 5-bit, 6-bit, 7-bit, or 8-bit; and
storing the four fp8 weight values based on the 2-bit descriptor for each fp8 weight value; and
using the stored fp8 weight values for inferencing using a machine learning model.

16. The computer-readable storage medium of claim 15, wherein the machine learning model is a large language model.

17. The computer-readable storage medium of claim 15, wherein zeros in most significant bits are not stored.

18. The computer-readable storage medium of claim 15, wherein bit representations of the weight values are not uniformly distributed in a histogram of the weight values.

19. The computer-readable storage medium of claim 15, further comprising computer-executable instructions that are structured such that, when executed by a processing system of a computing system, cause the computing system to perform operations comprising:
using k-means clustering to map k-bit weight values to floating point values;
storing the mapped floating point weight values; and
using the stored floating point weight values for inferencing the machine learning;
thereby minimizing error between encoded k-bit values and original weights that are output from training.

20. The computer-readable storage medium of claim 15, further comprising computer-executable instructions that are structured such that, when executed by a processing system of a computing system, cause the computing system to perform operations comprising:
selecting a base encoding depth k for encoding weight values for the machine learning model;
selecting at least some of possible k-bit values to have (k+1)-bit values;
storing weight values having depth k and other weight values having depth k+1; and
using the stored weight values for inferencing using the machine learning model;
thereby enabling weight independence and greater precision near zero and for large values.
